(19) United States
(12) Patent Application Publication
(10) Pub. No.: US 2025/0107606 A1
(43) Pub. Date: Apr. 3, 2025

(54) AEROSOL DYE

(71) Applicant: L'Oreal, Paris (FR)

(72) Inventors: Gregoire Charraud, Jersey City, NJ (US); Rafael Feliciano, New Providence, NJ (US)

(73) Assignee: L'Oreal, Paris (FR)

(21) Appl. No.: 18/812,174

(22) Filed: Aug. 22, 2024

Related U.S. Application Data
(60) Provisional application No. 63/586,171, filed on Sep. 28, 2023.

(30) Foreign Application Priority Data
Nov. 27, 2023 (FR) 2313065

(51) Int. Cl. A45D 20/12; B05B 17/04

(52) U.S. Cl. CPC A45D 20/12; B05B 17/04

(57) ABSTRACT

An attachment device for a hair dryer that includes an ion generator and aerosol applicator for facilitating applying and curing of a cosmetic composition, such as a hair dye, that is applied to hair of an individual. A hair dryer system that includes such an attachment device and a hair dryer. Methods of using the attachment device and/or a system for curing a cosmetic composition, and computational devices configured to perform all or part of the methods.

### CROSS-REFERENCE(S) TO RELATED APPLICATION(S)

This application claims the benefit of U.S. provisional application Ser. No. 63/586,171 filed Sep. 28, 2023, and French patent application serial no. FR 2313065 filed Nov. 27, 2023, the contents of which are incorporated by reference herein in their entirety for all purposes.

### SUMMARY

In an aspect, the disclosure provides an attachment for a hair dryer, the attachment comprising: an aerosol device that comprises an ion generator configured to ionize a cosmetic composition to generate an aerosolized cosmetic composition, and an applicator configured to transmit the aerosolized cosmetic composition from the applicator onto a portion of a body of an individual; wherein the attachment and the hair dryer are configured for concomitant use to apply and cure the cosmetic composition.

In embodiments, the attachment is attachable to the hair dryer with one or more securements configured to secure the attachment to the hair dryer.

In embodiments, the attachment is an after-market addition to the hair dryer.

In embodiments, the aerosolized cosmetic composition is for application to hair of an individual.

In embodiments, the aerosolized cosmetic composition includes a hair dye that is curable with hot air of the hair dryer, wherein the ion generator is configured for generation of ions in the hair dye prior to application to hair of the individual.

In embodiments, the applicator comprises a nozzle head configured to channel the aerosolized cosmetic composition to and through a nozzle aperture of the applicator for spraying the aerosolized cosmetic composition onto the portion of the body of the individual.

In embodiments, the attachment further comprises a thermal sensor and circuitry configured to compute a hair dryer blower level, a hair dryer blower temperature, and/or an applicator spray level based at least in part on data captured by the thermal sensor of the hair dryer and/or attachment.

In embodiments, the circuitry is configured to: activate an applicator of the attachment for application of an aerosolized cosmetic composition to the portion of the body of the individual; and activate a blower of the hair dryer; wherein the hair dryer blows air based at least in part on the hair dryer blower level, the hair dryer blower temperature, and/or the applicator spray level.

In an aspect, the disclosure provides a hair dryer system comprising an attachment, wherein the attachment is attached or is attachable a hair dryer of the hair dryer system.

In an aspect, the disclosure provides a method for applying an aerosolized cosmetic composition to a portion of a body of an individual, the method comprising: attaching an attachment to a hair dryer, wherein the attachment comprises an aerosol device configured to ionize a cosmetic composition to generate the aerosolized cosmetic composition, and an applicator configured to transmit the aerosolized cosmetic composition from the applicator onto a portion of a body of an individual; and activating the attachment to apply the aerosolized cosmetic composition to the portion of the body of the individual, and activating a blower of the hair dryer, wherein the hair dryer blows air to cure the cosmetic composition applied to the portion of the body of the individual.

In embodiments, the applicator comprises a nozzle head configured to channel the aerosolized cosmetic composition to and through a nozzle aperture of the applicator for spraying the aerosolized cosmetic composition onto the portion of the body of the individual.

In embodiments, the attachment and/or the hair dryer further comprises a thermal sensor and circuitry, and the method further comprises computing, with the circuitry, a hair dryer blower level, a hair dryer blower temperature, and/or an applicator spray level based at least in part on data captured by the thermal sensor.

In embodiments, the aerosolized cosmetic composition is for application to hair of the individual.

In embodiments, the aerosolized cosmetic composition includes a hair dye that is curable with hot air of the hair dryer.

In an aspect, the disclosure provides a computational device comprising circuitry configured to perform all or part of the method.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIG. 1 shows a schematic of an example hair dryer system for application of a cosmetic composition using an aerosol attachment of the system, according to aspects of the disclosure.

FIG. 2 shows an illustration of an example hair dryer system, including a hair dryer with an aerosol attachment (ion generator, aerosol dye with applicator) attached thereto, according to aspects of the disclosure.

FIG. 3 shows an example hair dryer system in use to apply an aerosolized dye composition to the hair of an individual, according to aspects of the disclosure.

FIG. 4 shows a flow chart of an example method for applying an aerosolized cosmetic composition to an individual's hair with an example hair dryer system, according to aspects of the disclosure.

TABLE 1
Drawings elements and descriptions.

| Reference | Description |
|---|---|
| 1 | Hair dryer system |
| 2 | Aerosol attachment device |
| 3 | Hair dryer |
| 4a | Rearward securement (aerosol attachment device) |
| 4b | Forward securement (aerosol attachment device) |
| 5a | Rearward securement (Hair dryer) |
| 5b | Forward securement (Hair dryer) |
| 6 | Securement rail |
| 9 | Individual's hair |
| 10 | Method for applying an aerosolized cosmetic |
| | composition to an individual's hair |
| 11 | Preparing an individual's hair for application of a |
| | cosmetic composition |
| 12 | Applying the cosmetic composition to the |
| | individual's hair with an applicator for a hair dryer |
| 13 | Curing the cosmetic composition with hot air of the |
| | hair dryer |
| 14a | Nozzle head |
| 14b | Nozzle aperture |

The foregoing aspects and many of the attendant advantages of this disclosure will become more readily appreciated as the same become better understood by reference to the following detailed description, when taken in conjunction with the accompanying drawings.

### DETAILED DESCRIPTION

Existing devices and methods for hair coloring typically utilize an oxidative chemical reaction that can be corrosive to tissues and is overly time consuming. With these approaches, typically, two compounds are mixed to form a hair dye composition, and the hair dye composition is then meticulously applied to the hair. These approaches take time but can be able to produce colored hair that lasts for three or more weeks. There is a need for devices and methods for efficiently applying aerosolized hair dye compositions onto the hair for heat-based curing of the compositions and satisfactory lasting of the colored hair. The present disclosure addresses this and other long-felt and unmet needs in the art.

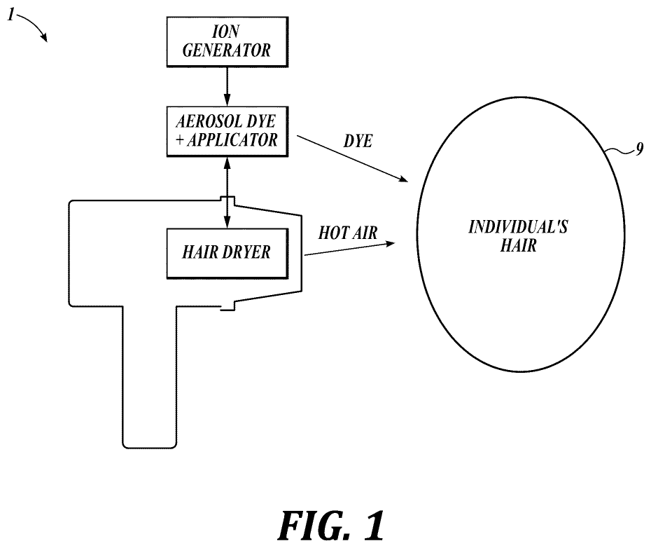

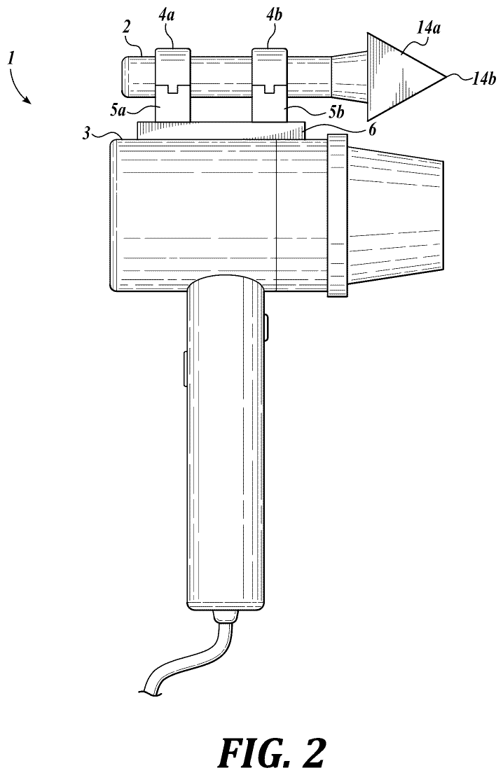

As shown at FIGS. 1 and 2, an example hair dryer system 1 for aerosolized application and heat curing of a cosmetic composition comprises an aerosol attachment device 2 affixed to a hair dryer 3. In embodiments, an aerosol attachment device 2 can be provided as an after-market device for attachment to a commercially available hair dryer 3, such as by way of rearward and forward securements 4a and 4b that are securable around the aerosol attachment device 2, and rearward and forward securements 5a and 5b that are securable around the hair dryer 3. Securements 4a and 4b can be connected to securements 5a and 5b to secure the aerosol attachment device 2 to the hair dryer 3.

In embodiments, securements 4a and 5a, and 4b and 5b, can be connected together with any suitable fastener, including but not necessarily limited to screws and threaded holes, hook and loop fasteners, complementary magnets, snap connectors, buckles, buttons, zippers, straps, and the like. In embodiments, positions or configurations of securements 4a and 5a, and 4b and 5b are adjustable, such that an angle of the aerosol attachment device 2 relative to the hair dryer 3 is adjustable, for example, for adjustment of alignment of a path of a dye composition sprayed from the aerosol attachment device 2 with a path of blown air of the hair dryer 3. Since different hair dryers 3 can be shaped differently, resulting in different angles between the aerosol path and the path of blown air, adjustment of the angle between the aerosol attachment device 2 and the hair dryer 3 can enable compensation for these differences and help the aerosol path be at least partially coincident with a point of impact of the blown air with hair of an individual during use of the system.

The aerosol attachment device can comprise a dye composition and an ion generator configured aerosolize the dye composition for being sprayed from an applicator of the aerosol attachment device. An applicator can comprise a nozzle head 14a and a nozzle aperture 14b; the nozzle head 14a can channel the dye composition into a smaller volume for being sprayed from the nozzle aperture 14b.

In embodiments, the hair dryer 3 can be provided from a factory, or can be equipped as an after-market addition, with a securement rail 6. The securement rail 6 can be comprised of one or more ridges along a length thereof for securement of securements 4a and 4b, and 5a and 5b, thereto at any position along the length of the securement rail 6. In example embodiments and for purposes of illustration, the securement rail 6, and the securements 4a and 4b, and 5a and 5b, can be considered to function in a manner that corresponds with that of a firearm optics rail with optics attachments, or the like. However, in embodiments, the attachment is integrated or integral with the hair dryer, such that the system is configured as a unit.

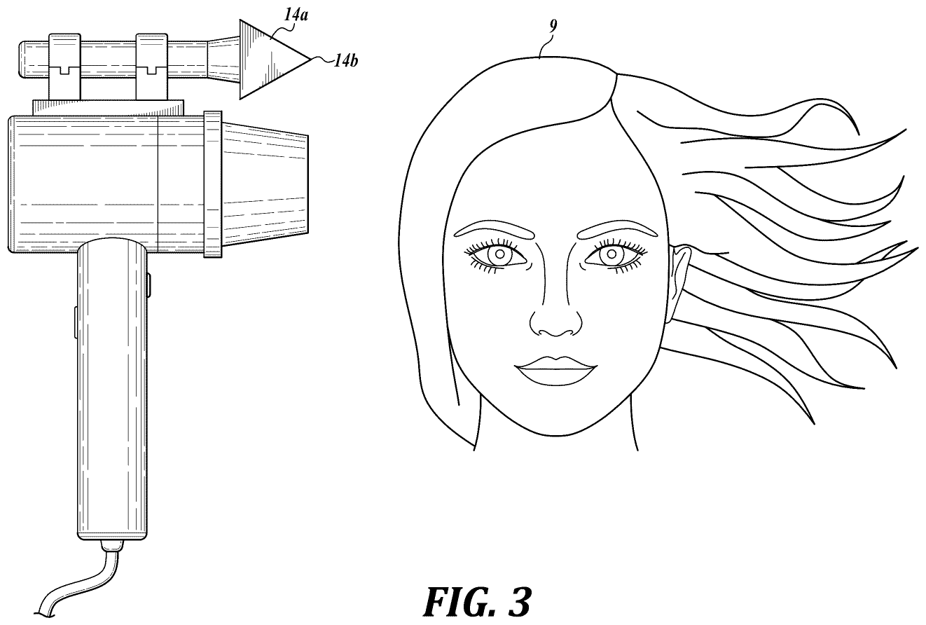

As shown at FIG. 3, a hair dryer system can be used to cure and dry a cosmetic composition applied to an individual's hair. As shown, a hair dryer system can include the aerosol attachment device attached to the hair dryer. During use, the aerosol attachment device can emit an aerosol spray path containing aerosolized dye composition, and the hair dryer can emit a blown air path. The aerosol spray path can be at least partially coincident with the blown air path at a portion of the individual's hair 9, or can contact the individual's hair at a position near or adjacent to a point of contact of the blown air path with the individual's hair, according to embodiments. A heat curable cosmetic composition (e.g., hair dye composition) can be cured by the blown air path, and the individual's hair dried of excess water or other liquid by the blown air path, simultaneously. In this manner, the time for curing and drying is reduced.

Accordingly, in embodiments, an attachment device for a hair dryer comprises an aerosol attachment device that is configured to cure a cosmetic composition, such as a hair dye, applied to an individual's hair. The aerosol spray path of the attachment can spray an area that is at, near, or adjacent to an output of the hair dryer when attached to the hair dryer, such that warm or hot air emitted by the hair dryer is at least partially coincident with the composition sprayed from the attachment. In embodiments, the cosmetic composition can be simultaneously applied and cured for improved application of the cosmetic composition.

In embodiments, the cosmetic composition is configured for application to the hair of an individual, such as the hair on the head. The cosmetic composition can be, or can include, a hair dye that is curable with hot air of the hair dryer. The hair dye can be for introduction of a hair color to the individual's hair, for example.

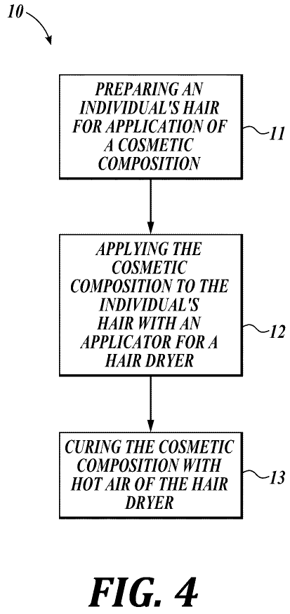

FIG. 4 shows a flow chart of an example method for applying an aerosolized cosmetic composition to an individual's hair with an example hair dryer system. A method 10 can include, at step 11, preparing an individual's hair for application of a cosmetic composition; at step 12, applying the cosmetic composition to the individual's hair with an applicator for a hair dryer; and at step 13, curing the cosmetic composition with hot air of the hair dryer. In embodiments, the hot air contacts the cosmetic composition applied to the hair. In embodiments, the attachment is attachable (and/or attached) to the hair dryer for ergonomic use of one or both of the blower and the aerosol dye applicator, such that a user does not need to change their grip or change out a device being held for use of these features of the combination.

In embodiments, a spray area of the aerosol attachment and, optionally, a portion of the hot air blown by the hair dryer, can be at least partially coincident, as a non-limiting example. This can facilitate a user to both style and color the hair with a combination device. As such, in embodiments, the cosmetic composition can be applied with a use of a combination device that includes the attachment and the hair dryer. In embodiments, application of the cosmetic composition can be adjusted, for example with a use of the combination device, for coating and coverage of the hair with the cosmetic composition. Example adjustments include activation and/or deactivation of application of the cosmetic composition as needed, adjustment of a distance between the combination device and the hair as needed, activation and/or deactivation of the aerosol attachment and/or the blower of the hair dryer as needed, and the like.

In embodiments, the hair can be treated with shampoo, conditioner, plasma, hot air, or any combination thereof, to change the surface texture of the hair and enhance penetration of the cosmetic composition into and adhesion to the hair. In embodiments, the hair is treated with shampoo before, during, and/or after application of the cosmetic composition to the hair. In embodiments, the hair is treated with conditioner before, during, and/or after application of the cosmetic composition to the hair. In embodiments, the hair is treated with plasma before, during, and/or after application of the cosmetic composition to the hair. In embodiments, the hair is treated with warm and/or hot air before, during, and/or after application of the cosmetic composition to the hair. In embodiments, an ion generator can be used to activate the aerosolized cosmetic composition, e.g., prior to application to the hair. In embodiments, one or more of these and/or other treatment(s) can be applied with a use of the combination device, for example.

In embodiments, the intensity of the aerosol attachment and/or the hair dryer blower, such as rate of aerosol and/or air movement and/or level of heat, can be adjusted as part of the application process. Such adjustments can be made based on a distance of the device from the hair or scalp of an individual, for example, to avoid excessive heating or damage to the hair or scalp. In embodiments, the cosmetic composition can be aerosolized and/or provided as a consumable for a use with the combination device; for example, the cosmetic composition can be provided as a cartridge or the like.

Referring back to FIG. 2, in at least some embodiments, an aerosol attachment device 2 can be configured for emission of an infrared (IR) light beam. In embodiments, the IR light beam can comprise, consist essentially of, or consist of a near IR band. In embodiments, the near IR band can be within the range of 650 to 850 nm wavelength, or any portion thereof. The IR light beam can, in embodiments, cure a cosmetic composition that is configured for management or improvement of hair fibers, for example. In embodiments, a cosmetic composition that is curable with the IR light beam is not or does not include a hair coloration composition.

In embodiments, a combination device includes a thermal sensor, placed within a middle portion of an air stream of the hair dryer, where the blown air is warmest. The thermal sensor can be configured to measure temperature of the blown air. The thermal sensor can be operably connected to control circuitry of the combination device; in embodiments, the control circuitry can increase or decrease temperature of the blown air by controlled activation or deactivation of a heating element of the hair dryer, for example. In embodiments, the control circuitry can be configured for computation of a cumulative power projected onto or near the individual's hair or scalp, as a sum of power output that includes the hair dryer. In embodiments, temperature of the blown air can be prioritized for reduction in the event that the cumulative power is above a threshold value, such that a hair coloration process (e.g., with a hair color composition) is not negatively impacted by excessive drying of the hair. In embodiments, the hot air blower can be automatically decreased or deactivated if the cumulative power is above a threshold value, for example, to reduce the risk of injury to the hair or scalp.

In various embodiments, the combination device can be a “smart hair dryer” that includes, among other features, one or more sensors (e.g., thermal sensor) that are operably connected with circuitry configured for performing logic operations based on data received from the one or more sensors for automated, semi-automated, or assisted manual application of the cosmetic composition to a portion of the body of an individual. The logic operations can include all or part of a method and/or process of the disclosure, for example, optionally in combination with additional logic operations. Attachment devices, hair dryers, and/or devices or systems of the disclosure can be provided as kits that include instructional materials configured to direct a user in a use of the kit.

As such, in aspects, the disclosure provides a “smart hair dryer” computational system or device comprising circuitry configured to perform all or part of a method, and in at least some aspects, a system and/or network of computational devices comprising at least part of such circuitry. In embodiments, a smart hair dryer computational device can include a form factor that corresponds to a form factor of a hair dryer, a hair dryer system, or the like, as disclosed herein. In embodiments, circuitry of such a computational device is configurable with a processor and processor-executable instructions stored on a non-transitory machine-readable medium of the computational device, as a non-limiting example, but other approaches for configuring circuitry of the computational device can be implemented in embodiments. In embodiments, the computational device includes a processor for execution of instructions stored on a non-transitory machine-readable medium, for enabling the processor to carry out all or part of a method or process of the disclosure. Accordingly, in embodiments, a computational device includes a software application configured to perform all or part of one or more methods or processes of the disclosure, in any order or combination. However, in embodiments, a computational device includes dedicated hardware circuitry. Further configuration of circuitry of the computational device can include networking circuitry, for example, circuitry configured for a wireless connection, such as a Bluetooth® connection, a Bluetooth® low energy (BLE) connection, and/or a Wi-Fi® connection, and/or a wired connection. The networking circuitry, in combination with circuitry of the computational device, can be used to request, retrieve, and/or receive data from a remote server, for example. In embodiments, the circuitry can include operable connection of one or more sensors with the processor, or other circuitry, for performing logic operations and/or methods based on data received from the one or more sensors, for example.

### Terminology

As used herein, including in the claims, the terms “a,” “an,” “the,” and the like, refer to the singular and the plural forms of the object or element referenced. The term “comprising” is inclusive or open-ended and does not exclude additional, unrecited elements or steps. The term “consisting of,” as used in a claim, excludes any element, step, or ingredient not specified in the claim. The term “consisting essentially of,” as used in a claim, limits the scope of the claim to the specified materials or steps and those that do not materially affect the basic and novel characteristic(s) of the claim.

As used herein, the term “device,” and similar terms, refers to an electronic device that is configured, or that can be configured, to perform all or part of a method or process of the disclosure. The term “system,” and similar terms, refers to two or more, i.e., multiple, devices that together are configured, or can be configured, to perform all or part of a method or process of the disclosure. Devices and systems can be operably connected by one or more electronic telecommunications connections or network connections for electronic communications that utilize one or more networking protocols for the transmission or exchange of data, for example, for carrying out all or part of a method as a computational method. The term “computational method” refers to a method, or a portion of a method, that is carried out substantially or entirely by a device or system, with little or no human or manual input.

As used herein, the term “instructional material,” and similar terms, refers to any material or media, whether print, audio, visual, illustrative, audiovisual, tactile, or otherwise, that can convey to an individual information about how to use a kit, device, system, or other aspect of the disclosure in a method or process for remote sebum measurement.

### Non-Limiting Embodiments

While general features of the disclosure are described and shown and particular features of the disclosure are set forth in the claims, the following non-limiting embodiments relate to features, and combinations of features, that are explicitly envisioned as being part of the disclosure. The following non-limiting Embodiments contain elements that are modular and can be combined with each other in any number, order, or combination to form a new non-limiting Embodiment, which can itself be further combined with other non-limiting Embodiments.

Embodiment 1. An attachment for a hair dryer, the attachment comprising: an aerosol device that comprises an ion generator configured to ionize a cosmetic composition to generate an aerosolized cosmetic composition, and an applicator configured to transmit the aerosolized cosmetic composition from the applicator onto a portion of a body of an individual; wherein the attachment and the hair dryer are configured for concomitant use to apply and cure the cosmetic composition.

Embodiment 2. The attachment of Embodiment 1 or any other Embodiment, wherein the attachment is attachable to the hair dryer with one or more securements configured to secure the attachment to the hair dryer.

Embodiment 3. The attachment of any one of Embodiments 1-2 or any other Embodiment, wherein the attachment is an after-market addition to the hair dryer.

Embodiment 4. The attachment of any one of Embodiment 1, wherein the aerosolized cosmetic composition is for application to hair of an individual.

Embodiment 5. The attachment of any one of Embodiments 1-4 or any other Embodiment, wherein the aerosolized cosmetic composition includes a hair dye that is curable with hot air of the hair dryer, wherein the ion generator is configured for generation of ions in the hair dye prior to application to hair of the individual.

Embodiment 6. The attachment of any one of Embodiments 1-5 or any other Embodiment, wherein the applicator comprises a nozzle head configured to channel the aerosolized cosmetic composition to and through a nozzle aperture of the applicator for spraying the aerosolized cosmetic composition onto the portion of the body of the individual.

Embodiment 7. The attachment of any one of Embodiments 1-6 or any other Embodiment, further comprising a thermal sensor and circuitry configured to compute a hair dryer blower level, a hair dryer blower temperature, and/or an applicator spray level based at least in part on data captured by the thermal sensor of the hair dryer and/or attachment.

Embodiment 8. The attachment of any one of Embodiments 1-7 or any other Embodiment, wherein the circuitry is configured to: activate an applicator of the attachment for application of an aerosolized cosmetic composition to the portion of the body of the individual; and activate a blower of the hair dryer; wherein the hair dryer blows air based at least in part on the hair dryer blower level, the hair dryer blower temperature, and/or the applicator spray level.

Embodiment 9. A hair dryer system comprising the attachment of any one of Embodiments 1-8 or any other Embodiment, wherein the attachment is attached or is attachable a hair dryer of the hair dryer system.

Embodiment 10. A method for applying an aerosolized cosmetic composition to a portion of a body of an individual, the method comprising: attaching an attachment to a hair dryer, wherein the attachment comprises an aerosol device configured to ionize a cosmetic composition to generate the aerosolized cosmetic composition, and an applicator configured to transmit the aerosolized cosmetic composition from the applicator onto a portion of a body of an individual; and activating the attachment to apply the aerosolized cosmetic composition to the portion of the body of the individual, and activating a blower of the hair dryer, wherein the hair dryer blows air to cure the cosmetic composition applied to the portion of the body of the individual.

Embodiment 11. The method of Embodiment 10 or any other Embodiment, wherein the applicator comprises a nozzle head configured to channel the aerosolized cosmetic composition to and through a nozzle aperture of the applicator for spraying the aerosolized cosmetic composition onto the portion of the body of the individual.

Embodiment 12. The method of any one of Embodiments 10-11 or any other Embodiment, wherein the attachment and/or the hair dryer further comprises a thermal sensor and circuitry, and the method further comprises computing, with the circuitry, a hair dryer blower level, a hair dryer blower temperature, and/or an applicator spray level based at least in part on data captured by the thermal sensor.

Embodiment 13. The method of any one of Embodiments 10-12 or any other Embodiment, wherein the aerosolized cosmetic composition is for application to hair of the individual.

Embodiment 14. The method of any one of Embodiments 10-13 or any other Embodiment, wherein the aerosolized cosmetic composition includes a hair dye that is curable with hot air of the hair dryer.

Embodiment 15. A computational device comprising circuitry configured to perform all or part of the method of any one of Embodiments 10-14 or any other Embodiment.

While illustrative embodiments have been illustrated and described, it will be appreciated that various changes can be made therein without departing from the spirit and scope of the invention.

1. An attachment for a hair dryer, the attachment comprising:
an aerosol device that comprises an ion generator configured to ionize a cosmetic composition to generate an aerosolized cosmetic composition, and an applicator configured to transmit the aerosolized cosmetic composition from the applicator onto a portion of a body of an individual;
wherein the attachment and the hair dryer are configured for concomitant use to apply and cure the cosmetic composition.

2. The attachment of claim 1, wherein the attachment is attachable to the hair dryer with one or more securements configured to secure the attachment to the hair dryer.

3. The attachment of claim 2, wherein the attachment is an after-market addition to the hair dryer.

4. The attachment of claim 1, wherein the aerosolized cosmetic composition is for application to hair of an individual.

5. The attachment of claim 4, wherein the aerosolized cosmetic composition includes a hair dye that is curable with hot air of the hair dryer, wherein the ion generator is configured for generation of ions in the hair dye prior to application to hair of the individual.

6. The attachment of claim 1, wherein the applicator comprises a nozzle head configured to channel the aerosolized cosmetic composition to and through a nozzle aperture of the applicator for spraying the aerosolized cosmetic composition onto the portion of the body of the individual.

7. The attachment of claim 1, further comprising a thermal sensor and circuitry configured to compute a hair dryer blower level, a hair dryer blower temperature, and/or an applicator spray level based at least in part on data captured by the thermal sensor of the hair dryer and/or attachment.

8. The attachment of claim 7, wherein the circuitry is configured to:
activate an applicator of the attachment for application of an aerosolized cosmetic composition to the portion of the body of the individual; and
activate a blower of the hair dryer; wherein the hair dryer blows air based at least in part on the hair dryer blower level, the hair dryer blower temperature, and/or the applicator spray level.

9. A hair dryer system comprising the attachment of claim 1, wherein the attachment is attached or is attachable a hair dryer of the hair dryer system.

10. A method for applying an aerosolized cosmetic composition to a portion of a body of an individual, the method comprising:
attaching an attachment to a hair dryer, wherein the attachment comprises an aerosol device configured to ionize a cosmetic composition to generate the aerosolized cosmetic composition, and an applicator configured to transmit the aerosolized cosmetic composition from the applicator onto a portion of a body of an individual; and
activating the attachment to apply the aerosolized cosmetic composition to the portion of the body of the individual, and activating a blower of the hair dryer, wherein the hair dryer blows air to cure the cosmetic composition applied to the portion of the body of the individual.

11. The method of claim 10, wherein the applicator comprises a nozzle head configured to channel the aerosolized cosmetic composition to and through a nozzle aperture of the applicator for spraying the aerosolized cosmetic composition onto the portion of the body of the individual.

12. The method of claim 10, wherein the attachment and/or the hair dryer further comprises a thermal sensor and circuitry, and the method further comprises computing, with the circuitry, a hair dryer blower level, a hair dryer blower temperature, and/or an applicator spray level based at least in part on data captured by the thermal sensor.

13. The method of claim 10, wherein the aerosolized cosmetic composition is for application to hair of the individual.

14. The method of claim 13, wherein the aerosolized cosmetic composition includes a hair dye that is curable with hot air of the hair dryer.

15. A computational device comprising circuitry configured to perform all or part of the method of claim 10.
